(19) United States
(12) Patent Application Publication
(10) Pub. No.: US 2024/0327269 A1
(43) Pub. Date: Oct. 3, 2024

(54) OPTICAL GLASS, OPTICAL ELEMENT, LIGHT GUIDE PLATE AND IMAGE DISPLAY DEVICE

(71) Applicants: HOYA CORPORATION, Tokyo (JP); HOYA OPTICAL TECHNOLOGY (WEIHAI) CO., LTD., ShanDong (CN)

(72) Inventor: Hayato SASAKI, Tokyo (JP)

(73) Assignees: HOYA CORPORATION, Tokyo (JP); HOYA OPTICAL TECHNOLOGY (WEIHAI) CO., LTD., ShanDong (CN)

(21) Appl. No.: 18/619,936

(22) Filed: Mar. 28, 2024

(30) Foreign Application Priority Data
Mar. 31, 2023 (JP) 2023-058566

(51) Int. Cl. C03C 3/068; G02B 27/01

(52) U.S. Cl. CPC C03C 3/068; G02B 6/0065; G02B 27/0172; G02B 6/0031; G02B 6/0055

(57) ABSTRACT

The optical glass includes SiO₂, B₂O₃, TiO₂, Nb₂O₅, Y₂O₃, La₂O₃, and Gd₂O₃ as essential components, in which, on a mass basis, a mass ratio of a B₂O₃ content to a SiO₂ content (B₂O₃/SiO₂) is less than 1.000, a mass ratio of Y₂O₃ content to a total content of Y₂O₃, La₂O₃, Gd₂O₃ and Yb₂O₃ (Y₂O₃/(Y₂O₃+La₂O₃+Gd₂O₃+Yb₂O₃)) is more than 0.020, and a refractive index nd is more than 2.00000.

### CROSS-REFERENCE TO RELATED APPLICATIONS

This application claims priority under 35 U.S.C 119 to Japanese Patent Application No. 2023-058566 filed on Mar. 31, 2023, which is hereby expressly incorporated by reference, in its entirety.

### TECHNICAL FIELD

The present disclosure relates to an optical glass, an optical element, a light guide plate and an image display device.

### BACKGROUND ART

For example, Japanese Patent No. 5931173 and Japanese Patent Application Publication No. 2019-116408, which are hereby expressly incorporated by reference, in their entirety, disclose optical glass with a high refractive index.

### SUMMARY

For optical glass with a high refractive index, for example, by combining a lens including such glass with another lens including glass having a different dispersibility to obtain a cemented lens, it is possible to make an optical system compact while correcting the color aberration. For this reason, such optical glass is useful as a material for an optical element configuring an image pickup optical system or a projection optical system such as a projector.

A light guide plate, i.e., a constituent member of an image display device, is also manufactured from optical glass. With optical glass with a high refractive index, a light guide plate with a wide viewing angle can be manufactured.

Regarding physical properties desired for optical glass, it is desirable for optical glass to have a glass surface that is not easily devitrified. For glass whose surface has been devitrified, a devitrified portion thereof has to be removed for processing into a lens, a light guide plate, or the like. Therefore, the surface devitrification may cause yield reduction. Further, glass whose surface has been devitrified has fogging on the glass surface. For this reason, it is difficult to perform quality check the inside of the glass.

In view of the foregoing circumstances, an aspect of the present disclosure provides for optical glass having a high refractive index and being suppressed in surface devitrification thereof.

One aspect of the present disclosure is as follows.

(1) An optical glass including SiO₂, B₂O₃, TiO₂, Nb₂O₅, Y₂O₃, La₂O₃, and Gd₂O₃ as essential components,
in which on a mass basis,
a mass ratio of a B₂O₃ content to a SiO₂ content (B₂O₃/SiO₂) is less than 1.000,
a mass ratio of Y₂O₃ content to a total content of Y₂O₃, La₂O₃, Gd₂O₃ and Yb₂O₃ (Y₂O₃/(Y₂O₃+La₂O₃+Gd₂O₃+Yb₂O₃)) is more than 0.020, and
a refractive index nd is more than 2.00000.
   (2) The optical glass according to (1), in which the mass ratio (Y₂O₃/(Y₂O₃+La₂O₃+Gd₂O₃+Yb₂O₃)) is more than 0.020 and 0.100 or less.
   (3) The optical glass according to (1) or (2), in which a mass ratio of a TiO₂ content to a total content of SiO₂ and B₂O₃ (TiO₂/(SiO₂+B₂O₃)) is 1.950 or more.
   (4) The optical glass according to any of (1) to (3), in which a total content of SiO₂ and B₂O₃ (SiO₂+B₂O₃) is 30.00 mass % or less.
   (5) The optical glass according to any of (1) to (4), in which the refractive index nd is 2.08000 or more.
   (6) The optical glass according to any of (1) to (5), in which a temperature TI, at which switching to melt is caused in differential scanning calorimetry, is 1247° C. or less.
   (7) The optical glass according to any of (1) to (6), in which a temperature TI, at which switching to melt is caused in differential scanning calorimetry, is 1245° C. or less.
   (8) The optical glass according to any of (1) to (7), in which
the mass ratio (Y₂O₃/(Y₂O₃+La₂O₃+Gd₂O₃+Yb₂O₃)) is more than 0.020 and 0.100 or less,
the mass ratio of the TiO₂ content to the total content of SiO₂ and B₂O₃ (TiO₂/(SiO₂+B₂O₃)) is 1.950 or more,
the total content of SiO₂ and B₂O₃ (SiO₂+B₂O₃) is 12.00 mass % or less,
the refractive index nd is 2.08000 or more, and
the temperature TI, at which switching to melt is caused in differential scanning calorimetry, is 1247° C. or less.
   (9) The optical glass according to (8), in which the temperature TI, at which switching to melt is caused in differential scanning calorimetry, is 1245° C. or less.
   (10) An optical element comprised of the optical glass according to any of (1) to (9).
   (11) A light guide plate comprised of the optical glass according to any of (1) to (9).
   (12) An image display device, including
an image display element, and
a light guide plate which guides a light emitted from the image display element, in which
the light guide plate is the light guide plate according to (11).

In accordance with one aspect of the present disclosure, it is possible to provide an optical glass having a high refractive index and being suppressed in surface devitrification thereof.

Further, in accordance with another aspect of the present disclosure, it is possible to provide an optical element and a light guide plate comprised of the above optical glass, and an image display device including the above light guide plate.

### BRIEF DESCRIPTION OF THE DRAWINGS

FIG. 1 is a photograph of a glass block (left) of optical glass No. 13 of Example 1 and a glass block (right) of optical glass of Comparative Example 1;

FIG. 2 is a schematic block view of one example (head mount display) of an image device including an image display element and a light guide plate; and

FIG. 3 is a side view schematically showing a configuration of the head mount display 1 shown in FIG. 2.

### DESCRIPTION OF THE EMBODIMENTS

### Optical Glass

In the present disclosure and in the present specification, the glass composition is expressed by the glass composition on an oxide basis. Herein, the term “glass composition on an oxide basis” represents the glass composition resulting from conversion on the assumption that the glass raw material is fully decomposed at the time of melting, and is present as an oxide in glass. Further, the glass composition is expressed on a mass basis (mass %, mass ratio) unless otherwise specified.

The glass composition in the present disclosure and the present specification can be determined by, for example, the method such as ICP-AES (Inductively Coupled Plasma-Atomic Emission Spectrometry). The quantitative analysis is performed for every element using the ICP-AES. Subsequently, the analysis value is converted to oxide notation. The analysis value by the ICP-AES may include, for example, a measurement error of about +5% of the analysis value. Therefore, the value expressed in terms of oxide converted from the analysis value may also similarly include an error of about +5%.

Further, in the present disclosure and in the present specification, the constituent component having a content of 0%, 0.00%, or 0.000%, or not being included nor introduced means that the constituent component is substantially not included, and indicates that the content of the constituent component is equal to or lower than approximately the impurity level. The term “being equal to or lower than approximately the impurity level” means, for example, being less than 0.01%.

The above optical glass (which is also simply described as “glass”) includes SiO₂, B₂O₃, TiO₂, Nb₂O₅, Y₂O₃, La₂O₃, and Gd₂O₃ as essential components. In such glass, the mass ratio of the B₂O₃ content to the SiO₂ content (B₂O₃/SiO₂) being less than 1.000, and the mass ratio of the Y₂O₃ content to the total content of Y₂O₃, La₂O₃, Gd₂O₃ and Yb₂O₃ (Y₂O₃/(Y₂O₃+La₂O₃+Gd₂O₃+Yb₂O₃)) being more than 0.020 can contribute to suppression of the surface devitrification.

Below, the glass composition of the above optical glass will be further described in details.

### Glass Composition

The mass ratio of the B₂O₃ content to the SiO₂ content (B₂O₃/SiO₂) is less than 1.000, can be 0.980 or less, 0.960 or less, 0.950 or less, 0.920 or less, or 0.900 or less from the viewpoint of suppressing the surface devitrification, and from the viewpoint of reducing the TI described later. The mass ratio (B₂O₃/SiO₂) can be, for example, 0.100 or more, 0.200 or more, 0.300 or more, 0.400 or more, 0.500 or more, or 0.600 or more.

The mass ratio of the Y₂O₃ content to the total content of Y₂O₃, La₂O₃, Gd₂O₃, and Yb₂O₃ (Y₂O₃/(Y₂O₃+La₂O₃+Gd₂O₃+Yb₂O₃)) is more than 0.020, can be 0.021 or more, 0.022 or more, 0.023 or more, 0.024 or more, or 0.025 or more from the viewpoint of suppressing the surface devitrification, and from the viewpoint of reducing the TI. The mass ratio (Y₂O₃/(Y₂O₃+La₂O₃+Gd₂O₃+Yb₂O₃)) can be, for example, 0.100 or less, 0.090 or less, 0.080 or less, 0.070 or less, 0.060 or less, or 0.050 or less.

The above optical glass includes SiO₂, B₂O₃, TiO₂, Nb₂O₅, Y₂O₃, La₂O₃, and Gd₂O₃ as essential components.

SiO₂ is a network-forming oxide, and is a component capable of contributing to keeping of the glass stability, keeping of the viscosity suitable for molding molten glass and improvement of the chemical durability thereof. The enhancement of the glass stability leads to suppression of the surface devitrification of glass, and hence is preferable. The SiO₂ content of the above optical glass can be 0.10% or more, 0.50% or more, 1.00% or more, 2.00% or more, 3.00% or more, 4.00% or more, or 5.00% or more. From the viewpoints of the suppression of the reduction of the refractive index and keeping of the glass meltability, the SiO₂ content can be 30.00% or less, 20.00% or less, 15.00% or less, 10.00% or less, 8.00% or less, or 6.00% or less.

B₂O₃ is a network-forming oxide, and is a component capable of contributing to keeping of the glass meltability and the improvement of the glass stability. The B₂O₃ content of the above optical glass can be 0.10% or more, 0.50% or more, 1.00% or more, 2.00% or more, 3.00% or more, 4.00% or more, or 5.00% or more. From the viewpoints of suppression of the reduction of the refractive index and suppression of the reduction of the chemical durability, the B₂O₃ content can be 30.00% or less, 20.00% or less, 15.00% or less, 10.00% or less, 8.00% or less, or 6.00% or less.

From the viewpoint of the improvement of the glass stability, the total content of SiO₂ and B₂O₃ (SiO₂+B₂O₃) can be 1.00% or more, 3.00% or more, 5.00% or more, 8.00% or more, or 10.00% or more. From the viewpoint of increasing the refractive index of glass, the total content (SiO₂+B₂O₃) can be 30.00% or less, 20.00% or less, 15.00% or less, 13.00% or less, or 12.00% or less.

TiO₂ is a component capable of contributing to an increase in refractive index of glass, and the improvement of the chemical durability thereof. The TiO₂ content of the above optical glass can be 1.00% or more, 3.00% or more, 5.00% or more, 8.00% or more, 10.00% or more, 13.00% or more, 15.00% or more, 18.00% or more, or 20.00% or more. From the viewpoint of suppression of the reduction of the glass stability, the TiO₂ content can be 50.00% or less, 45.00% or less, 40.00% or less, 35.00% or less, 30.00% or less, 28.00% or less, or 26.00% or less.

The mass ratio of the TiO₂ content to the total content of SiO₂ and B₂O₃ (TiO₂/(SiO₂+B₂O₃)) can be 1.950 or more, 1.960 or more, 1.970 or more, 1.980 or more, 1.990 or more, or 2.000 or more from the viewpoint of increasing the refractive index of glass. From the viewpoint of the improvement of the glass stability, the mass ratio (TiO₂/(SiO₂+B₂O₃)) can be 10.000 or less, 8.000 or less, 5.000 or less, 3.000 or less, 2.800 or less, or 2.500 or less.

Nb₂O₅ is a component capable of contributing to an increase in refractive index of glass, and the improvement of the chemical durability thereof. The Nb₂O₅ content of the above optical glass can be 1.00% or more, 2.00% or more, 3.00% or more, 4.00% or more, 5.00% or more, or 6.00% or more. From the viewpoint of suppression of the reduction of the glass stability, the Nb₂O₅ content can be 30.00% or less, 20.00% or less, 15.00% or less, 10.00% or less, or 8.00% or less.

The WO₃ content of the above optical glass can be 0.00%, 0.00% or more, or more than 0.00%. WO₃ is a component capable of contributing to an increase in refractive index of glass and the improvement of the chemical durability thereof. The WO₃ content can be, for example, 8.00% or less, 7.00% or less, 6.00% or less, or 5.00% or less.

The total content of TiO₂, Nb₂O₅, and WO₃ (TiO₂+Nb₂O₅+WO₃) can be 10.00% or more, 15.00% or more, 20.00% or more, 25.00% or more, 28.00% or more, or 30.00% or more from the viewpoints of an increase in the refractive index of glass, and the improvement of the chemical durability thereof. From the viewpoint of improving the glass stability, the total content (TiO₂+Nb₂O₅+WO₃) can be 60.00% or less, 55.00% or less, 50.00% or less, 45.00% or less, 40.00% or less, 38.00% or less, or 35.00% or less.

Y₂O₃ is a component capable of contributing to an increase in refractive index of glass, keeping of the low dispersibility thereof, and the improvement of the chemical durability. The Y₂O₃ content of the above optical glass can be 0.10% or more, 0.30% or more, 0.50% or more, 0.80% or more, or 1.00% or more. From the viewpoints of suppression of the reduction of the glass stability and suppression of an increase in TI, the Y₂O₃ content can be 10.00% or less, 8.00% or less, 5.00% or less or 3.00% or less.

La₂O₃ is also a component capable of contributing to an increase in refractive index of glass, keeping of the low dispersibility thereof, and the improvement of the chemical durability. The La₂O₃ content of the above optical glass can be 10.00% or more, 15.00% or more, 20.00% or more, 25.00% or more, 30.00% or more, or 35.00% or more. From the viewpoints of suppression of the reduction of the glass stability and suppression of an increase in TI, the La₂O₃ content can be 60.00% or less, 55.00% or less, 50.00% or less, 45.00% or less, or 40.00% or less.

Gd₂O₃ is also a component capable of contributing to an increase in refractive index of glass, keeping of the low dispersibility thereof, and the improvement of the chemical durability. The Gd₂O₃ content of the above optical glass can be 1.00% or more, 2.00% or more, 3.00% or more, 4.00% or more, 5.00% or more, or 6.00% or more. From the viewpoints of suppression of the reduction of the glass stability and suppression of an increase in TI, the Gd₂O₃ content can be 30.00% or less, 20.00% or less, 15.00% or less, 10.00% or less, or 8.00% or less.

The Yb₂O₃ content can be 0.00%, 0.00% or more, or more than 0.00%. Yb₂O₃ is also a component capable of contributing to an increase in refractive index of glass, keeping of the low dispersibility thereof, and the improvement of the chemical durability. The Yb₂O₃ content of the above optical glass can be, for example, 5.00% or less, 4.00% or less, 3.00% or less, 2.00% or less, 1.00% or less, 0.50% or less, or 0.10% or less.

The total content of Y₂O₃, La₂O₃, Gd₂O₃, and Yb₂O₃ (Y₂O₃+La₂O₃+Gd₂O₃+Yb₂O₃) can be 10.00% or more, 15.00% or more, 20.00% or more, 25.00% or more, 30.00% or more, 35.00% or more, 40.00% or more, 43.00% or more, or 45.00% or more, from the viewpoints of an increase in the refractive index of glass, keeping of the low dispersibility, and improving the chemical durability. From the viewpoints of suppression of the reduction of the glass stability, and suppression of an increase in TI, the total content (Y₂O₃+La₂O₃+Gd₂O₃+Yb₂O₃) can be 70.00% or less, 65.00% or less, 60.00% or less, 55.00% or less, 53.00% or less, or 50.00% or less.

Each content of Li₂O, Na₂O, K₂O, and Cs₂O can be 0.00%, 0.00% or more, more than 0.00%, 0.05% or more, or 0.10% or more. Further, each content of Li₂O, Na₂O, K₂O, and Cs₂O can be, for example, 5.00% or less, 4.00% or less, 3.00% or less, 2.00% or less, or 1.00% or less.

All of Li₂O, Na₂O, K₂O, and Cs₂O each have an action of improving the thermal stability of glass. An increase in the content thereof tends to result in a decrease in refractive index and chemical durability. For this reason, each content of Li₂O, Na₂O, K₂O, and Cs₂O can fall within the foregoing range.

Each content of MgO, CaO, SrO, and BaO can be 0.00%, 0.00% or more, more than 0.00%, 0.05% or more, or 0.10% or more. Further, each content of MgO, CaO, SrO, and BaO can be, for example, 5.00% or less, 4.00% or less, 3.00% or less, 2.00% or less, or 1.00% or less.

All of MgO, CaO, SrO, and BaO each have an action of improving the thermal stability of glass. An increase in the content thereof tends to result in a decrease in refractive index. For this reason, each content of MgO, CaO, SrO, and BaO can fall within the foregoing range.

The ZnO content can be 0.00%, 0.00% or more, more than 0.00%, 0.05% or more, 0.10% or more, or 1.00% or more. Further, the ZnO content can be, for example, 5.00% or less, 4.00% or less, 3.00% or less, or 2.00% or less.

ZnO has an action of improving the thermal stability of glass. An increase in content of ZnO tends to result in an increase in specific gravity. For this reason, the content of ZnO can fall within the foregoing range.

The ZrO₂ content can be 0.00%, 0.00% or more, more than 0.00%, 1.00% or more, 3.00% or more, or 5.00% or more. Further, the ZrO₂ content can be, for example, 10.00% or less or 8.00% or less.

ZrO₂ has an action of increasing the refractive index of glass. An increase in content of ZrO₂ tends to result in a decrease in thermal stability of glass. For this reason, the content of ZrO₂ can fall within the foregoing range.

The Ta₂O₅ content can be 0.00%, 0.00% or more, more than 0.00%, 0.05% or more, or 0.10% or more. Further, the Ta₂O₅ content can be, for example, 5.00% or less, 4.00% or less, 3.00% or less, 2.00% or less, or 1.00% or less.

Ta₂O₅ has an action of increasing the refractive index of glass. An increase in content of Ta₂O₅ tends to result in a decrease in thermal stability of glass. For this reason, the content of Ta₂O₅ can fall within the foregoing range.

The above optical glass can further include one or more of P₂O₅, Al₂O₃, and the like in addition to the foregoing components.

The P₂O₅ content can be 0.00% or more, 10.00% or less, 8.00% or less, 6.00% or less, 4.00% or less, 2.00% or less, 1.00% or less, or 0.50% or less.

The Al₂O₃ content can be 0.00% or more, 10.00% or less, 8.00% or less, 6.00% or less, 4.00% or less, 2.00% or less, 1.00% or less, or 0.50% or less.

Pb, As, Cd, TI, Be, and Se respectively have toxicity. For this reason, the above elements can be prevented from being included, namely, the above elements can be prevented from being introduced into glass as glass components.

U, Th, and Ra are all radioactive elements. For this reason, the above elements can be prevented from being included, namely, the above elements can be prevented from being introduced into glass as glass components.

V, Cr, Mn, Fe, Co, Ni, Cu, Pr, Nd, Pm, Sm, Eu, Tb, Dy, Ho, Er, Tm, and Ce increase the coloration of glass, and become the source of generation of fluorescence, and are not preferable as the elements to be included in glass for an optical element. For this reason, the above elements can be prevented from being included, namely, the above elements can be prevented from being introduced into glass as glass components.

Sb and Sn are optional elements each functioning as a clarifying agent.

The amount of Sb to be added can be set within the range of 0.000 to 0.100 mass %, within the range of 0.001 to 0.020 mass %, within the range of 0.001 to 0.010 mass %, or within the range of 0.001 to 0.005 mass % for every 100 mass % of the total content of other glass components than Sb₂O₃ in terms of Sb₂O₃.

The amount of Sn to be added can be set within the range of 0.000 to 0.100 mass %, within the range of 0.000 to 0.020 mass %, within the range of 0.000 to 0.010 mass %, or within the range of 0.000 to 0.005 mass % for every 100 mass % of the total content of other glass components than SnO₂ in terms of SnO₂.

### Glass Physical Properties

### Refractive Index nd

The refractive index nd of the above optical glass is more than 2.00000, can be 2.01000 or more, 2.02000 or more, 2.03000 or more, 2.04000 or more, 2.05000 or more, 2.06000 or more, 2.07000 or more, or 2.08000 or more. The refractive index nd of the above optical glass can be, for example, 2.20000 or less, 2.15000 or less, 2.14000 or less, 2.13000 or less, 2.12000 or less, 2.11000 or less, or 2.10000 or less. In the present disclosure and in the present specification, the term “refractive index” means the “refractive index nd”.

### Abbe's Number vd

The Abbe's number vd is the value indicative of the property regarding the dispersibility, and is expressed as vd=(nd−1)/(nF−nC) using respective refractive indices nd, nF, and nC in the d line, the F line, and the C line. From the viewpoint of usability as a material for an optical element and a light guide plate material, the Abbe's number vd of the above optical glass can be 20.00 or more, 21.00 or more, 22.00 or more, or 23.00 or more. From the same viewpoint, the Abbe's number vd can be 30.00 or less, 28.00 or less, 26.00 or less, 25.00 or less, or 24.00 or less.

### Glass Transition Temperature Tg

The glass transition temperature Tg of the above optical glass can be 560° C. or more from the viewpoint of machinability. Glass with a high glass transition temperature tends to be less likely to be broken upon undergoing machining of glass such as cutting, shaving, grinding, or polishing, and hence is preferable. From the viewpoint of the machinability, the glass transition temperature Tg can be 570° C. or more, 580° C. or more, 590° C. or more, or 600° C. or more. On the other hand, from the viewpoint of reducing the burden on an annealing furnace or a mold, the glass transition temperature Tg can be 800° C. or less, 790° C. or less, 780° C. or less, 770° C. or less, 760° C. or less, or 750° C. or less.

The glass transition temperature Tg is determined in the following manner. With differential scanning calorimetry, upon a temperature rise of a glass sample, endothermic behavior in association with a change in specific heat, namely, an endothermic peak occurs. Upon a further temperature rise, an exothermic peak occurs. Differential scanning calorimetric analysis provides a DSC (Differential Scanning calorimetry) curve with the temperature on the horizontal axis, and the amount corresponding to exotherm/endotherm of the sample on the vertical axis. The point of Intersection between the tangent line at the point at which the slope is maximized when the endothermic peak appears from the baseline in the curve and the baseline is assumed to be the glass transition temperature Tg. The measurement of the glass transition temperature Tg can be performed using the one obtained by sufficiently grinding glass by a mortar or the like as a sample, at a heating rate of 10° C./min using a differential scanning calorimeter.

### Temperature TI

The present inventors newly found that the glass with a low temperature TI at which transition to a melt is caused with the differential scanning calorimetry is less likely to undergo surface devitrification. The TI of the above optical glass can be 1247° C. or less, 1246° C. or less, 1245° C. or less, 1244° C. or less, 1243° C. or less, 1242° C. or less, 1241° C. or less, or 1240° C. or less. The TI of the above optical glass can be, for example, 1200° C. or more, 1210° C. or more, or 1220° C. or more. However, from the viewpoint of suppressing the surface devitrification, a lower TI is more preferable. For this reason, the TI of the above optical glass may be less than the foregoing range.

The temperature TI is determined as the temperature of the point of intersection between the tangent line at the point at which the slope is maximized over from the top of the endothermic peak due to fusion to the baseline, and the baseline from the DSC curve. The temperature of the point of intersection is the temperature which is h in FIG. 5 of “NEW GLASS, Vol. 28, No. 110 2013”, which is hereby expressly incorporated by reference, in its entirety.

### Specific Gravity

For an optical element configuring an optical system, the refractive power is determined by the refractive index of the glass configuring the optical element and the curvature of the optical functional surface (the surface upon and from which a light beam to be controlled is incident and emitted) of the optical element. When the curvature of the optical functional surface is tried to be increased, the thickness of the optical element is also increased. As a result, the optical element becomes heavy. In contrast, when glass with a high refractive index is used, a large refractive power can be obtained even if the curvature of the optical functional surface is not increased.

From the description up to this point, when the refractive index can be increased while suppressing an increase in specific gravity of glass, it becomes possible to reduce the weight of the optical element having a given refractive power.

Further, also for glass configuring a light guide plate, a low specific gravity is preferable from the viewpoints of the weight reduction of the light guide plate and the weight reduction of an image display device.

From the viewpoints described up to this point, the specific gravity of the above optical glass can be 5.30 or less, 5.20 or less, or 5.10 or less. A lower specific gravity is more preferable from the viewpoint of the weight reduction of the optical element. For this reason, the specific gravity of the optical glass has no particular restriction on the lower limit. In one embodiment, the specific gravity can be 4.00 or more, 4.40 or more, or 4.800 or more.

The optical glass described above is useful as a glass material for an optical element and a glass material for a light guide plate.

### Method for Manufacturing Glass

The above optical glass can be obtained in the following manner. An oxide, a carbonic acid salt, a sulfuric acid salt, a nitric acid salt, hydroxide, and the like of raw materials are weighed and prepared so as to obtain the objective glass composition, and are sufficiently mixed, resulting in a mixed batch. Heating, melting, deaeration, and stirring are performed in a melting container, thereby forming molten glass which is homogeneous and does not include foam, and the resulting molten glass is molded. Specifically, the optical glass can be formed using a known melting method.

### Glass Material for Press Molding, and Optical Element Blank, and Manufacturing Method Thereof

Another aspect of the present disclosure relates to:
a glass material for press molding comprised of the above optical glass; and
an optical element blank comprised of the above optical glass.

In accordance with a still other aspect of the present disclosure also provides:
a method for manufacturing a glass material for press molding including molding the above optical glass into a glass material for press molding;
a method for manufacturing an optical element blank, including press molding the above glass material for press molding using a mold for press molding, thereby manufacturing an optical element blank; and
a method for manufacturing an optical element blank, including molding the above optical glass into an optical element blank.

The optical element blank is an optical element base material closely analogous in shape to the objective optical element, and obtained by adding the polishing margin (the surface layer to be removed by polishing), and if required, a grinding margin (the surface layer to be removed by grinding), to the shape of the optical element. The surface of the optical element blank is ground and polished, thereby finishing an optical element. In one embodiment, an optical element blank can be manufactured by a method in which the molten glass obtained by melting the glass in a proper amount is press molded (which is referred to as a direct press method). In another embodiment, the optical element blank can also be manufactured by solidifying the molten glass obtained by melting a proper amount of the glass.

Still further, in a still other aspect, a glass material for press molding is manufactured. The manufactured glass material for press molding is press molded. As a result, an optical element blank can be manufactured.

Press molding of the glass material for press molding can be performed with a known method in which a glass material for press molding in a heated and softened state is pressed with a mold for press molding. Both of heating and press molding can be performed in the atmosphere. By reducing the strain inside the glass with annealing after press molding, it is possible to obtain a homogeneous optical element blank.

Examples of the glass materials for press molding include those to be subjected to machining such as cutting, grinding, and polishing, and to go through a glass gob for press molding for being subjected to press molding, in addition to those referred to as a glass gob for press molding to be subjected to press molding for manufacturing an optical element blank in the as-is state. Examples of the cutting methods include a method in which a groove is formed at the portion to be cut of the surface of a glass sheet with a process referred to as scribing, and the portion of the groove is applied with a local pressure from the back surface of the surface including the groove formed therein, thereby breaking the glass sheet at the portion of the groove; a method in which a glass sheet is cut by a cutting blade; and other methods. Further, examples of the grinding and polishing methods include barrel polishing, and the like.

The glass material for press molding can be manufactured, for example, in the following manner. Molten glass is casted in a mold, and molded into a glass sheet. The glass sheet is cut into a plurality of glass pieces. Alternatively, a glass gob for press molding can also be manufactured by molding a proper amount of molten glass. An optical element blank can also be manufactured by reheating and softening, and press molding the glass gob for press molding. The method in which glass is reheated and softened, and is press molded, thereby manufacturing an optical element blank is referred to as a reheat press method in contrast to the direct press method.

### Optical Element and Manufacturing Method Thereof

A still other aspect of the present disclosure relates to:
an optical element comprised of the above optical glass.

The above optical element is manufactured using the above optical glass. In the above optical element, one or more layers of coating such as a multilayer film of, for example, an antireflection film may be formed on the glass surface.

Further, one aspect of the present disclosure also provides:
a method for manufacturing an optical element including grinding and/or polishing the above optical element blank, and thereby manufacturing an optical element.

With the above method for manufacturing an optical element, to grinding and polishing, a known method may be applied. After processing, the optical element surface is subjected to sufficient cleaning, and drying, and the like. As a result, it is possible to obtain an optical element with a high inside quality and surface quality. In this manner, the optical element comprised of the above glass can be obtained. Examples of the optical element include various lenses such as a spherical lens, an aspherical lens, and a microlens; prisms; and the like.

Further, the optical element comprised of the above optical glass is also preferable as a lens configuring a cemented optical element. Examples of the cemented optical element include the one including lenses cemented to each other therein (cemented lens), and the one including a lens and a prism cemented to each other therein. For example, the cemented optical element can be manufactured in the following manner. The joint surfaces of two optical elements to be cemented are precisely processed (for example, spherically polished) so that the shapes may become the inverted shapes. An ultraviolet ray curable adhesive for use in adhesion of a cemented lens is applied, and an ultraviolet ray is applied through the lens after bonding, thereby curing the adhesive. The above glass is preferable for manufacturing a cemented optical element in this manner. A plurality of optical elements to be cemented are respectively manufactured using a plurality of kinds of glasses having different Abbe's numbers vd, and are cemented, which can result in the elements preferable for correction of the chromatic aberration.

### Light Guide Plate, Image Display Device

A still further aspect of the present disclosure relates to:
a light guide plate comprised of the above optical glass;
an image display device including:
an image display element and a light guide plate which guides a light emitted from the image display element, in which the light guide plate is a light guide plate comprised of the above optical glass. Specific embodiments of the image display device will be described later.

### EXAMPLES

Below, the present disclosure will be further described in details by way of Examples. However, the present disclosure is not limited to the embodiments shown in Examples.

### Example 1

In order to achieve the glass composition shown in the following table, using a nitric acid salt, a sulfuric acid salt, a carbonic acid salt, a hydroxide, an oxide, boric acid, and the like as the raw materials for introducing respective components, the raw materials were weighed, and sufficiently mixed, resulting in a prepared raw material.

The prepared raw material was placed in a crucible made of platinum, and was heated and molten. After melting, the molten glass was poured into a mold, and was allowed to cool to around the glass transition temperature, immediately followed by being placed in an annealing furnace. An annealing treatment was performed within the glass transition temperature range for about 1 hour. Then, the glass was allowed to cool to room temperature in the furnace, resulting in respective optical glasses of Nos. 1 to 40 shown in the following table. The unit of the content in the following table is mass %. The Sb₂O₃ content is the content for every 100 mass % of the total content of other glass components than Sb₂O₃.

### Comparative Examples 1 and 2

Glass with the glass composition shown in the following table was manufactured by the method described for Example 1, resulting in each optical glass of Comparative Examples 1 and 2. Comparative Example 1 corresponds to Example 1 of Japanese Patent No. 5931173, and Comparative Example 2 corresponds to Example 11 of Japanese Patent Application Publication No. 2019-116408.

Various physical properties of each optical glass of Examples and Comparative Examples are shown in the following table. The various physical properties of each optical glass were measured with the methods shown below.

### Evaluation of Physical Properties of Optical Glass

### (1) Refractive Index nd and Abbe's Number vd

As for the glass obtained by temperature drop at a temperature dropping rate of −30° C./hour, the refractive index nd and the Abbe's number vd were measured with the refractive index measuring method of the Japan Optical Glass Manufacturers' Association standard.

### (2) Glass Transition Temperature Tg and Temperature TI

With the one obtained by sufficiently grinding glass in a mortar as a sample, using a differential scanning calorie analyzer (DSC3300SA) manufactured by NETZSCH Co., DSC measurement was performed at a heating rate of 10° C./min, resulting in a DSC curve. From the resulting DSC curve, the glass transition temperature Tg and the temperature TI at which switching to melt is caused were determined as described previously.

### (3) Specific Gravity

The specific gravity was measured with the Archimedes method.

Each glass block of each optical glass of Nos. 1 to 40 of Example 1, and each optical glass of Comparative Example 1 and Comparative Example 2 were visually observed. As a result, in the glass block of each optical glass of Example 1, no surface devitrification was observed. In contrast, it was confirmed that surface devitrification was caused in the glass block of the optical glass of Comparative Example 1 and the glass block of the optical glass of Comparative Example 2.

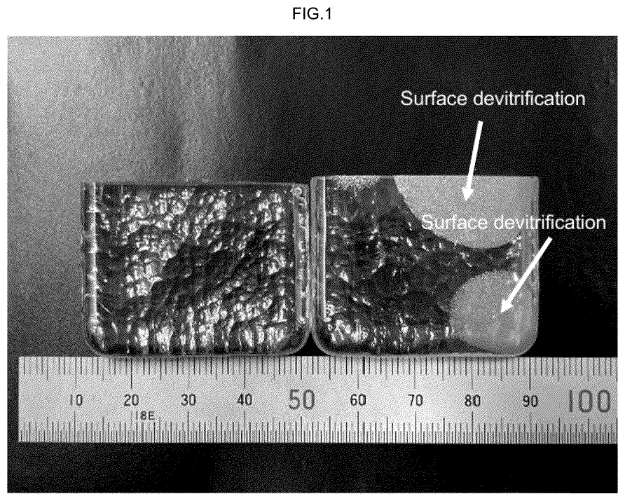

FIG. 1 is a photograph of the glass block (left) of the optical glass of No. 13 of Example 1 and the glass block (right) of the optical glass of Comparative Example 1. It can be confirmed that surface devitrification is caused in the glass block of the optical glass of Comparative Example 1.

TABLE 1

| No. | 1 | 2 | 3 | 4 | 5 |
|---|---|---|---|---|---|
| SiO₂ | 6.06 | 5.43 | 5.53 | 5.53 | 5.55 |
| B₂O₃ | 4.70 | 4.67 | 5.43 | 5.43 | 5.46 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 0.00 |
| ZnO | 1.31 | 1.30 | 1.32 | 0.52 | 1.33 |
| TiO₂ | 24.87 | 24.69 | 24.32 | 25.11 | 25.22 |
| Nb₂O₅ | 8.01 | 7.95 | 8.09 | 8.09 | 8.12 |
| WO₃ | 0.00 | 0.00 | 0.00 | 0.00 | 0.00 |
| ZrO₂ | 6.47 | 6.42 | 6.53 | 6.53 | 5.34 |
| Y₂O₃ | 1.07 | 1.61 | 1.64 | 1.64 | 1.64 |
| La₂O₃ | 40.41 | 40.89 | 39.99 | 40.00 | 40.16 |
| Gd₂O₃ | 7.09 | 7.04 | 7.16 | 7.16 | 7.19 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.000 | 0.005 | 0.005 | 0.005 | 0.005 |
| SiO₂ + B₂O₃ | 10.76 | 10.10 | 10.96 | 10.96 | 11.01 |
| TiO₂ + Nb₂O₅ + WO₃ | 32.89 | 32.64 | 32.41 | 33.20 | 33.34 |
| Y₂O₃ + La₂O₃ + Gd₂O₃ + Yb₂O₃ | 48.57 | 49.54 | 48.78 | 48.79 | 48.99 |
| B₂O₃/SiO₂ | 0.776 | 0.859 | 0.983 | 0.983 | 0.983 |
| Y₂O₃/(Y₂O₃ + La₂O₃ + Gd₂O₃ + Yb₂O₃) | 0.022 | 0.032 | 0.034 | 0.034 | 0.034 |
| TiO₂/(SiO₂ + B₂O₃) | 2.311 | 2.444 | 2.220 | 2.291 | 2.291 |
| nd | 2.09721 | 2.10189 | 2.09116 | 2.09631 | 2.09418 |
| vd | 23.31 | 23.39 | | 23.27 | 23.26 |
| Specific gravity | 5.01 | 5.05 | 5.00 | 4.99 | 4.98 |
| Tg(° C.) | 736 | 746 | 735 | 741 | 733 |
| Tl(° C.) | 1243 | 1241 | 1224 | 1231 | 1226 |
| No. | 6 | 7 | 8 | 9 | 10 |
| SiO₂ | 5.53 | 5.54 | 5.54 | 5.54 | 5.55 |
| B₂O₃ | 5.43 | 5.45 | 5.44 | 5.44 | 5.45 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 0.00 |
| ZnO | 0.92 | 0.93 | 0.93 | 0.92 | 0.93 |
| TiO₂ | 24.72 | 25.18 | 25.16 | 25.15 | 25.21 |
| Nb₂O₅ | 8.09 | 7.45 | 8.10 | 8.10 | 8.12 |
| WO₃ | 0.00 | 0.00 | 0.00 | 0.00 | 0.00 |
| ZrO₂ | 6.53 | 6.55 | 5.94 | 6.54 | 6.56 |
| Y₂O₃ | 1.64 | 1.64 | 1.64 | 1.08 | 1.64 |
| La₂O₃ | 39.99 | 40.10 | 40.08 | 40.06 | 39.35 |
| Gd₂O₃ | 7.16 | 7.18 | 7.17 | 7.17 | 7.19 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 10.96 | 10.99 | 10.98 | 10.98 | 11.00 |
| TiO₂ + Nb₂O₅ + WO₃ | 32.80 | 32.63 | 33.27 | 33.25 | 33.33 |
| Y₂O₃ + La₂O₃ + Gd₂O₃ + Yb₂O₃ | 48.78 | 48.91 | 48.89 | 48.31 | 48.18 |
| B₂O₃/SiO₂ | 0.983 | 0.983 | 0.983 | 0.983 | 0.983 |
| Y₂O₃/(Y₂O₃ + La₂O₃ + Gd₂O₃ + Yb₂O₃) | 0.034 | 0.034 | 0.034 | 0.022 | 0.034 |
| TiO₂/(SiO₂ + B₂O₃) | 2.255 | 2.291 | 2.291 | 2.291 | 2.291 |
| nd | 2.09427 | 2.09457 | 2.09521 | 2.09586 | 2.09630 |
| vd | 23.39 | 23.33 | 23.25 | | 23.18 |
| Specific gravity | 5.00 | 4.99 | 4.99 | 4.98 | 4.98 |
| Tg(° C.) | 737 | 738 | 736 | 734 | 733 |
| Tl(° C.) | 1224 | 1226 | 1224 | 1224 | 1235 |

TABLE 2

| No. | 11 | 12 | 13 | 14 | 15 |
|---|---|---|---|---|---|
| SiO₂ | 5.55 | 5.51 | 5.80 | 6.09 | 6.37 |
| B₂O₃ | 5.46 | 5.25 | 5.07 | 4.90 | 4.72 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 0.00 |
| ZnO | 0.93 | 0.92 | 0.92 | 0.92 | 0.92 |
| TiO₂ | 25.24 | 25.05 | 25.02 | 24.99 | 24.96 |
| Nb₂O₅ | 8.13 | 8.07 | 8.06 | 8.05 | 8.04 |
| WO₃ | 0.00 | 0.00 | 0.00 | 0.00 | 0.00 |
| ZrO₂ | 6.56 | 6.51 | 6.51 | 6.50 | 6.49 |
| Y₂O₃ | 1.64 | 1.63 | 1.63 | 1.63 | 1.63 |
| La₂O₃ | 40.19 | 39.90 | 39.85 | 39.81 | 39.76 |
| Gd₂O₃ | 6.30 | 7.14 | 7.13 | 7.12 | 7.11 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 11.01 | 10.76 | 10.87 | 10.98 | 11.09 |
| TiO₂ + Nb₂O₅ + WO₃ | 33.36 | 33.12 | 33.08 | 33.04 | 33.00 |
| Y₂O₃ + La₂O₃ + Gd₂O₃ + Yb₂O₃ | 48.13 | 48.68 | 48.62 | 48.56 | 48.50 |
| B₂O₃/SiO₂ | 0.983 | 0.952 | 0.875 | 0.804 | 0.741 |
| Y₂O₃/(Y₂O₃ + La₂O₃ + Gd₂O₃ + Yb₂O₃) | 0.034 | 0.034 | 0.034 | 0.034 | 0.034 |
| TiO₂/(SiO₂ + B₂O₃) | 2.291 | 2.328 | 2.301 | 2.275 | 2.250 |
| nd | 2.09617 | 2.09768 | 2.09636 | 2.09526 | 2.09370 |
| vd | 23.20 | | 23.25 | 23.29 | 23.33 |
| Specific gravity | 4.97 | 5.00 | 4.99 | 4.99 | 4.98 |
| Tg(° C.) | 735 | 739 | 740 | 742 | 745 |
| Tl(° C.) | 1233 | 1227 | 1229 | 1234 | 1236 |
| No. | 16 | 17 | 18 | 19 | 20 |
| SiO₂ | 5.83 | 6.13 | 6.43 | 5.49 | 5.82 |
| B₂O₃ | 5.44 | 5.44 | 5.45 | 5.06 | 5.09 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 0.00 |
| ZnO | 0.92 | 0.92 | 0.93 | 0.92 | 0.92 |
| TiO₂ | 24.35 | 23.98 | 23.61 | 24.93 | 25.48 |
| Nb₂O₅ | 8.09 | 8.10 | 8.11 | 8.68 | 7.43 |
| WO₃ | 0.00 | 0.00 | 0.00 | 0.00 | 0.00 |
| ZrO₂ | 6.54 | 6.54 | 6.55 | 6.48 | 6.52 |
| Y₂O₃ | 1.64 | 1.64 | 1.64 | 1.62 | 1.63 |
| La₂O₃ | 40.03 | 40.07 | 40.11 | 39.71 | 39.96 |
| Gd₂O₃ | 7.16 | 7.17 | 7.18 | 7.11 | 7.15 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 11.26 | 11.57 | 11.88 | 10.54 | 10.90 |
| TiO₂ + Nb₂O₅ + WO₃ | 32.44 | 32.08 | 31.72 | 33.61 | 32.91 |
| Y₂O₃ + La₂O₃ + Gd₂O₃ + Yb₂O₃ | 48.83 | 48.88 | 48.93 | 48.44 | 48.74 |
| B₂O₃/SiO₂ | 0.933 | 0.888 | 0.847 | 0.921 | 0.875 |
| Y₂O₃/(Y₂O₃ + La₂O₃ + Gd₂O₃ + Yb₂O₃) | 0.034 | 0.034 | 0.034 | 0.034 | 0.034 |
| TiO₂/(SiO₂ + B₂O₃) | 2.161 | 2.072 | 1.988 | 2.365 | 2.337 |
| nd | 2.08720 | 2.08428 | 2.07913 | 2.09997 | 2.09683 |
| vd | | 23.69 | 23.89 | | 23.26 |
| Specific gravity | 4.98 | 4.98 | 4.97 | 5.00 | 4.99 |
| Tg(° C.) | 735 | 738 | 738 | 737 | 740 |
| Tl(° C.) | 1225 | 1225 | 1223 | 1235 | 1236 |

TABLE 3

| No. | 21 | 22 | 23 | 24 | 25 |
|---|---|---|---|---|---|
| SiO₂ | 5.83 | 5.79 | 5.82 | 5.81 | 5.80 |
| B₂O₃ | 5.10 | 5.06 | 5.09 | 5.08 | 5.07 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 0.00 |
| ZnO | 0.92 | 0.92 | 0.92 | 0.92 | 0.92 |
| TiO₂ | 25.94 | 24.96 | 25.08 | 25.05 | 25.00 |
| Nb₂O₅ | 6.79 | 8.04 | 8.08 | 8.07 | 8.05 |
| WO₃ | 0.00 | 0.00 | 0.00 | 0.00 | 0.00 |
| ZrO₂ | 6.54 | 6.49 | 6.52 | 6.51 | 6.50 |
| Y₂O₃ | 1.64 | 1.07 | 2.19 | 1.63 | 1.63 |
| La₂O₃ | 40.06 | 40.55 | 39.15 | 40.69 | 39.02 |
| Gd₂O₃ | 7.17 | 7.11 | 7.15 | 6.25 | 8.01 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 10.93 | 10.85 | 10.90 | 10.88 | 10.86 |
| TiO₂ + Nb₂O₅ + WO₃ | 32.73 | 33.00 | 33.16 | 33.11 | 33.05 |
| Y₂O₃ + La₂O₃ + Gd₂O₃ + Yb₂O₃ | 48.87 | 48.74 | 48.49 | 48.57 | 48.66 |
| B₂O₃/SiO₂ | 0.875 | 0.875 | 0.875 | 0.875 | 0.875 |
| Y₂O₃/(Y₂O₃ + La₂O₃ + Gd₂O₃ + Yb₂O₃) | 0.034 | 0.022 | 0.045 | 0.034 | 0.033 |
| TiO₂/(SiO₂ + B₂O₃) | 2.373 | 2.301 | 2.301 | 2.301 | 2.301 |
| nd | 2.09695 | 2.09465 | 2.09612 | 2.09664 | 2.09656 |
| vd | | 23.32 | | 23.26 | 23.30 |
| Specific gravity | 4.98 | 5.00 | 4.99 | 4.99 | 5.00 |
| Tg(° C.) | 740 | 737 | 739 | 740 | 739 |
| Tl(° C.) | 1239 | 1236 | 1235 | 1235 | 1231 |
| No. | 26 | 27 | 28 | 29 | 30 |
| SiO₂ | 5.77 | 5.83 | 5.80 | 5.80 | 5.73 |
| B₂O₃ | 4.71 | 5.44 | 5.08 | 5.07 | 4.68 |
| Li₂O | 0.00 | 0.00 | 0.00 | 0.00 | 0.00 |
| CaO | 0.00 | 0.00 | 0.00 | 0.00 | 0.00 |
| BaO | 0.00 | 0.00 | 0.00 | 0.00 | 1.48 |
| ZnO | 1.71 | 0.12 | 0.92 | 0.92 | 0.91 |
| TiO₂ | 24.91 | 25.14 | 25.03 | 25.01 | 24.74 |
| Nb₂O₅ | 8.02 | 8.10 | 7.41 | 8.71 | 7.97 |
| WO₃ | 0.00 | 0.00 | 0.00 | 0.00 | 0.00 |
| ZrO₂ | 6.48 | 6.54 | 7.11 | 5.90 | 6.43 |
| Y₂O₃ | 1.62 | 1.64 | 1.63 | 1.63 | 1.61 |
| La₂O₃ | 39.67 | 40.04 | 39.87 | 39.84 | 39.40 |
| Gd₂O₃ | 7.10 | 7.16 | 7.14 | 7.13 | 7.05 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 10.49 | 11.27 | 10.88 | 10.87 | 10.41 |
| TiO₂ + Nb₂O₅ + WO₃ | 32.93 | 33.23 | 32.45 | 33.72 | 32.70 |
| Y₂O₃ + La₂O₃ + Gd₂O₃ + Yb₂O₃ | 48.40 | 48.84 | 48.64 | 48.59 | 48.06 |
| B₂O₃/SiO₂ | 0.816 | 0.933 | 0.875 | 0.875 | 0.816 |
| Y₂O₃/(Y₂O₃ + La₂O₃ + Gd₂O₃ + Yb₂O₃) | 0.034 | 0.034 | 0.034 | 0.034 | 0.034 |
| TiO₂/(SiO₂ + B₂O₃) | 2.375 | 2.231 | 2.301 | 2.301 | 2.375 |
| nd | 2.09882 | 2.09379 | 2.09620 | 2.09739 | 2.09485 |
| vd | 23.26 | 23.29 | 23.37 | 23.14 | 23.39 |
| Specific gravity | 5.02 | 4.97 | 5.00 | 4.99 | 5.02 |
| Tg(° C.) | 739 | 743 | 742 | 733 | 746 |
| Tl(° C.) | 1239 | 1236 | 1235 | 1231 | 1242 |

TABLE 4

| No. | 31 | 32 | 33 | 34 | 35 |
|---|---|---|---|---|---|
| SiO₂ | 5.76 | 5.75 | 5.74 | 5.72 | 5.63 |
| B₂O₃ | 5.04 | 5.02 | 5.02 | 5.00 | 4.93 |
| Li₂O | 0.00 | 0.00 | 0.00 | 0.00 | 0.00 |
| CaO | 0.00 | 0.00 | 0.00 | 0.00 | 0.00 |
| BaO | 1.49 | 0.00 | 0.00 | 0.00 | 0.00 |
| ZnO | 0.12 | 0.91 | 0.91 | 0.91 | 0.89 |
| TiO₂ | 24.85 | 24.78 | 24.76 | 23.89 | 22.78 |
| Nb₂O₅ | 8.00 | 6.69 | 7.97 | 7.94 | 7.83 |
| WO₃ | 0.00 | 2.25 | 2.25 | 2.24 | 4.41 |
| ZrO₂ | 6.46 | 6.44 | 5.24 | 6.41 | 6.32 |
| Y₂O₃ | 1.62 | 1.61 | 1.61 | 1.61 | 1.58 |
| La₂O₃ | 39.58 | 39.47 | 39.44 | 39.27 | 38.70 |
| Gd₂O₃ | 7.08 | 7.06 | 7.06 | 7.03 | 6.93 |
| Yb₂O₃ | 0.00 | 0.00 | 0.00 | 0.00 | 0.00 |
| Ta₂O₅ | 0.00 | 0.00 | 0.00 | 0.00 | 0.00 |
| Total | 100.00 | 100.00 | 100.00 | 100.00 | 100.00 |
| Sb₂O₃ | 0.005 | 0.005 | 0.005 | 0.005 | 0.005 |
| SiO₂ + B₂O₃ | 10.80 | 10.77 | 10.76 | 10.72 | 10.56 |
| TiO₂ + Nb₂O₅ + WO₃ | 32.85 | 33.72 | 34.98 | 34.06 | 35.02 |
| Y₂O₃ + La₂O₃ + Gd₂O₃ + Yb₂O₃ | 48.28 | 48.15 | 48.11 | 47.90 | 47.21 |
| B₂O₃/SiO₂ | 0.875 | 0.875 | 0.875 | 0.875 | 0.875 |
| Y₂O₃/(Y₂O₃ + La₂O₃ + Gd₂O₃ + Yb₂O₃) | 0.034 | 0.034 | 0.034 | 0.034 | 0.034 |
| TiO₂/(SiO₂ + B₂O₃) | 2.301 | 2.301 | 2.301 | 2.229 | 2.157 |
| nd | 2.09223 | 2.09521 | 2.09672 | 2.09435 | 2.09225 |
| vd | | | 23.06 | 23.32 | 23.38 |
| Specific gravity | 5.00 | 5.03 | 5.02 | 5.04 | 5.08 |
| Tg(° C.) | 744 | 739 | 734 | 736 | 735 |
| Tl(° C.) | 1230 | 1227 | 1239 | 1233 | 1244 |
| No. | 36 | 37 | 38 | 39 | 40 |
| SiO₂ | 5.84 | 5.82 | 5.80 | 5.75 | 5.49 |
| B₂O₃ | 5.11 | 5.09 | 5.07 | 4.86 | 5.40 |
| Li₂O | 0.15 | 0.00 | 0.00 | 0.00 | 0.00 |
| CaO | 0.00 | 0.55 | 0.00 | 0.00 | 0.00 |
| BaO | 0.00 | 0.00 | 0.00 | 0.00 | 0.00 |
| ZnO | 0.12 | 0.12 | 0.00 | 0.91 | 0.88 |
| TiO₂ | 25.19 | 25.09 | 25.93 | 24.80 | 23.04 |
| Nb₂O₅ | 8.11 | 8.08 | 8.06 | 7.99 | 8.32 |
| WO₃ | 0.00 | 0.00 | 0.00 | 0.00 | 0.00 |
| ZrO₂ | 6.55 | 6.52 | 6.51 | 6.45 | 6.59 |
| Y₂O₃ | 1.64 | 1.63 | 1.63 | 1.62 | 1.40 |
| La₂O₃ | 40.12 | 39.95 | 39.86 | 39.50 | 40.99 |
| Gd₂O₃ | 7.18 | 7.15 | 7.13 | 7.07 | 7.88 |
| Yb₂O₃ | 0.00 | 0.00 | 0.00 | 0.00 | 0.00 |
| Ta₂O₅ | 0.00 | 0.00 | 0.00 | 1.07 | 0.00 |
| Total | 100.00 | 100.00 | 100.00 | 100.00 | 99.99 |
| Sb₂O₃ | 0.005 | 0.005 | 0.005 | 0.005 | 0.005 |
| SiO₂ + B₂O₃ | 10.95 | 10.90 | 10.88 | 10.61 | 10.89 |
| TiO₂ + Nb₂O₅ + WO₃ | 33.30 | 33.16 | 33.99 | 32.78 | 31.36 |
| Y₂O₃ + La₂O₃ + Gd₂O₃ + Yb₂O₃ | 48.93 | 48.74 | 48.63 | 48.18 | 50.27 |
| B₂O₃/SiO₂ | 0.875 | 0.875 | 0.875 | 0.845 | 0.984 |
| Y₂O₃/(Y₂O₃ + La₂O₃ + Gd₂O₃ + Yb₂O₃) | 0.034 | 0.034 | 0.034 | 0.034 | 0.028 |
| TiO₂/(SiO₂ + B₂O₃) | 2.301 | 2.301 | 2.384 | 2.338 | 2.116 |
| nd | 2.09576 | 2.09364 | 2.09946 | 2.09927 | 2.08776 |
| vd | 23.27 | 23.37 | | 23.20 | 23.86 |
| Specific gravity | 4.98 | 4.97 | 4.97 | 5.02 | 5.04 |
| Tg(° C.) | 734 | 745 | 744 | 740 | 740 |
| Tl(° C.) | 1229 | 1232 | 1232 | 1247 | 1236 |

TABLE 5

| | Comparative | Comparative |
|---|---|---|
| No. | Example 1 | Example 2 |
| SiO₂ | 5.98 | 4.85 |
| B₂O₃ | 4.22 | 5.88 |
| Li₂O | 0.00 | 0.10 |
| CaO | 0.00 | 0.00 |
| BaO | 0.00 | 0.00 |
| ZnO | 1.36 | 0.00 |
| TiO₂ | 26.21 | 16.15 |
| Nb₂O₅ | 7.66 | 9.58 |
| WO₃ | 0.00 | 0.75 |
| ZrO₂ | 6.83 | 6.60 |
| Y₂O₃ | 0.54 | 7.15 |
| La₂O₃ | 39.90 | 48.94 |
| Gd₂O₃ | 7.32 | 0.00 |
| Yb₂O₃ | 0.00 | 0.00 |
| Ta₂O₅ | 0.00 | 0.00 |
| Total | 100.02 | 100.00 |
| Sb₂O₃ | 0.000 | 0.000 |
| SiO₂ + B₂O₃ | 10.20 | 10.73 |
| TiO₂ + Nb₂O₅ + WO₃ | 33.87 | 26.48 |
| Y₂O₃ + La₂O₃ + Gd₂O₃ + Yb₂O₃ | 47.76 | 56.09 |
| B₂O₃/SiO₂ | 0.706 | 1.212 |
| Y₂O₃/(Y₂O₃ + La₂O₃ + Gd₂O₃ + Yb₂O₃) | 0.011 | 0.127 |
| TiO₂/(SiO₂ + B₂O₃) | 2.570 | 1.505 |
| nd | 2.10958 | 2.04908 |
| vd | 22.83 | 26.86 |
| Specific gravity | 5.01 | 5.12 |
| Tg(° C.) | 735 | 757 |
| Tl(° C.) | 1252 | 1283 |

### Example 2

Using the various glasses obtained in Example 1, a glass block (glass gob) for press molding was manufactured. The glass block was heated and softened in the atmosphere, and was press molded in a mold for press molding, thereby manufacturing a lens blank (optical element blank). The manufactured lens blank was taken out from the mold for press molding, and was annealed, and was subjected to machining including polishing, thereby manufacturing a spherical lens including each optical glass of Example 1.

### Example 3

The molten glass manufactured in Example 1 was press molded in a desired amount in a mold for press molding, thereby manufacturing a lens blank (optical element blank). The manufactured lens blank was taken out from the mold for press molding, and was annealed, and was subjected to machining including polishing, thereby manufacturing a spherical lens including each optical glass of Example 1.

### Example 4

The glass block (optical element blank) manufactured by solidifying the molten glass manufactured in Example 1 was annealed, and was subjected to machining including polishing, thereby manufacturing a spherical lens including each optical glass of Example 1.

### Example 5

Each spherical lens manufactured in Examples 2 to 4 was bonded with a spherical lens including other kinds of glasses, thereby manufacturing a cemented lens.

### Example 6

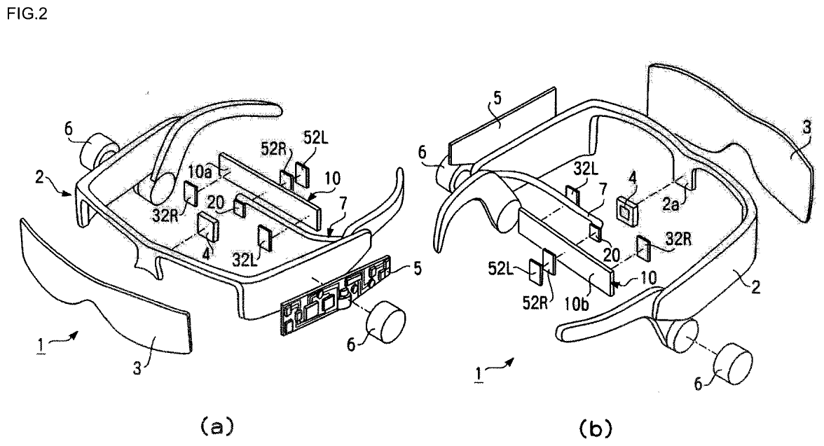

FIG. 2 is a schematic block view of a head mount display of one example of an image device including an image display element and a light guide plate. A head mount display 1 having the configuration shown in FIG. 2 was manufactured in the following manner.

Each optical glass of Example 1 was processed into a rectangular thin sheet shape with length 50 mm×width 20 mm×thickness 1.0 mm, resulting in a light guide plate 10.

The light guide plate was mounted to the head mount display 1 (which will be hereinafter abbreviated as “HMD 1”) shown in FIG. 2. FIG. 2(a) is a front surface side perspective view of the HMD 1, and FIG. 2(b) is a back surface side perspective view of the HMD 1. As shown in FIG. 2(a) and FIG. 2(b), an eyeglass lens 3 is mounted to the front surface part of an eyeglass type frame 2 to be mounted on the head part of a user. A back light 4 for illuminating an image is mounted on the mounting part 2a of the eyeglass type frame 2. A signal processing instrument 5 for showing an image, and a speaker 6 for reproducing a sound are provided at the temple portion of the eyeglass type frame 2. A FPC (Flexible Printed Circuits) 7 configuring the wire led out from the circuit of the signal processing instrument 5 is wired along the eyeglass type frame 2. The display element unit (for example, liquid crystal display element) 20 is wired to the center position of both eyes of a user by the FPC 7, and is held so that substantially the central part of the display element unit 20 may be arranged on the optical axis of the back light 4. The display element unit 20 is relatively fixed with respect to the light guide plate 10 so as to be situated at substantially the central part of the light guide plate 10. Further, at the site situated in front of user's eyes, HOEs (Holographic Optical Elements) 32R and 32L (first optical elements) are fixed in close contact with the top of a first surface 10a of the light guide plate 10 by adhesion or the like, respectively. At the position opposed to the display element unit 20 across the light guide plate 10, HOEs 52R and 52L are stacked on a second surface 10b of the light guide plate 10.

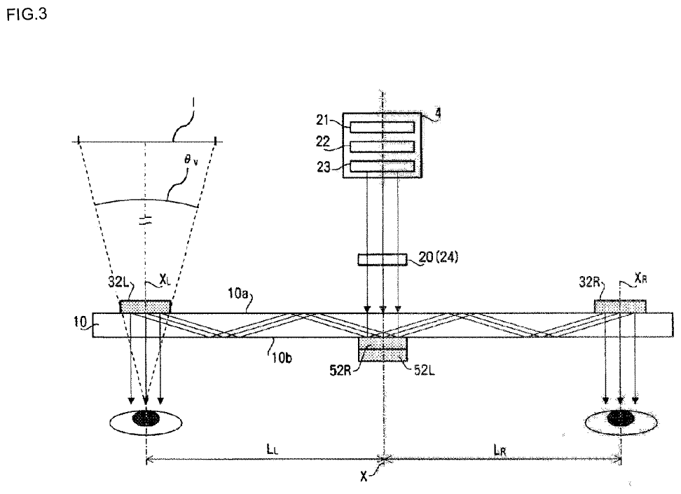

FIG. 3 is a side view schematically showing a configuration of the HMD 1 shown in FIG. 2. In FIG. 3, in order to make the drawing clear, only the main part is shown, and the eyeglass type frame 2, and the like are not shown. As shown in FIG. 3, the HMD 1 has a structure bilaterally symmetric across the center line X connecting the centers of the image display element 24 and the light guide plate 10. Further, the lights with respective wavelengths made incident upon the light guide plate 10 from the image display element 24 are divided into two parts as described later, to be guided to the right eye and the left eye, respectively. The optical path of the light with respective wavelengths to be guided to respective eyes is also bilaterally symmetric across the center line X.

As shown in FIG. 3, the back light 4 has a laser light source 21, a diffusion optical system 22, and a microlens array 23. The display element unit 20 is an image generating unit having the image display element 24, and is driven by, for example, a Field Sequential system. The laser light source 21 has a laser light source compatible with respective wavelengths of B (wavelength 436 nm), G (wavelength 546 nm), and R (wavelength 633 nm), and sequentially applies lights with respective wavelengths at a high speed. The light with each wavelength is made incident upon the diffusion optical system 22, and the microlens array 23, and is converted to a parallel luminous flux without light quantity unevenness and with a uniformly high directivity, to be made incident perpendicularly to the display panel surface of the image display element 24.

The image display element 24 is, for example, a transmission type liquid crystal (LCDT-LCOS) panel to be driven by a field sequential system. The image display element 24 applies the light of each wavelength with modulation in response to the image signal generated by an image engine (not shown) of the signal processing instrument 5. The light of each wavelength modulated with the pixel in the effective region of the image display element 24 is made incident with a prescribed luminous flux cross section (substantially the same shape as that of the effective region) on the light guide plate 10. The image display element 24 can also be replaced with a display element in, for example, another form such as a DMD (Digital Mirror Device), a reflection type liquid crystal (LCOS) panel, MEMS (Micro Electro Mechanical Systems), an organic EL (Electro-Luminescence), or an inorganic EL.

The display element unit 20 is not limited to the display element of a field sequential system, and may be assumed as an image forming unit of the simultaneous display element (a display element having RGB color filters in a prescribed array at the emitting surface front surface). In this case, for the light source, for example, a white light source is used.

As shown in FIG. 3, the lights with respective wavelengths modulated by the image display element 24 are sequentially made incident upon the inside of the light guide plate 10 from the first surface 10a. On a second surface 10b of the light guide plate 10, the HOEs 52R and 52L (second optical elements) are stacked. The HOEs 52R and 52L are each, for example, a reflection type volume phase type HOE having a rectangular shape, and has a configuration in which three photopolymers respectively including the interference fringes corresponding to lights with respective wavelengths of R, G, and B recorded thereon are stacked. Namely, the HOEs 52R and 52L are configured so as to have a wavelength selecting function of diffracting the light with respective wavelengths of R, G, and B, and transmitting the lights with other wavelengths.

Both the HOEs 32R and 32L are each also a reflection type volume phase type HOE, and have the same layer structure as that of the HOEs 52R and 52L. The HOEs 32R and 32L, and 52R and 52L may have, for example, substantially the same pitch of the interference fringes pattern.

The HOEs 52R and 52L are stacked with the mutual centers in alignment with each other, and the interference fringes pattern inverted 180 (deg). Then, the HOEs 52R and 52L are fixed tightly on the second surface 10b of the light guide plate 10 in a stacked state by adhesion or the like so that the centers thereof may be in alignment with the center line X. Upon the HOEs 52R and 52L, lights with respective wavelengths modulated by the image display element 24 are sequentially made incident via the light guide plate 10.

The HOEs 52R and 52L diffract the lights with respective wavelengths sequentially made incident at a prescribed angle in order to guide the lights to the right eye and the left eye. The lights with respective wavelengths diffracted by the HOEs 52R and 52L respectively repeatedly undergo total reflection at the interface between the light guide plate 10 and air, and propagate through the inside of the light guide plate 10, to be made incident upon the HOEs 32R and 32L. Herein, the HOEs 52R and 52L give the same diffraction angle to the lights with respective wavelengths. For this reason, the lights with all the wavelengths to be made incident upon substantially the same positions with respect to the light guide plate 10 (or in other words, emitted from substantially the same coordinates in the effective region of the image display element 24) propagate through substantially the same optical paths in the inside of the light guide plate 10, and are made incident upon substantially the same positions on the HOEs 32R and 32L. From another viewpoint, the HOEs 52R and 52L diffract the lights with respective wavelengths of RGB so that the pixel positional relationship in the effective region of the image displayed in the effective region of the image display element 24 may be reproduced on the HOEs 32R and 32L truly.

As described above, in the present Example, the HOEs 52R and 52L respectively diffract the lights with all the wavelengths emitted from substantially the same coordinates in the effective region of the image display element 24 so that the lights may be made incident upon substantially the same positions of the HOEs 32R and 32L. Alternatively, the HOEs 52R and 52L may be configured such that the lights with all the wavelengths forming originally the same pixels relatively shifted in the effective region of the image display element 24 may be made incident upon substantially the same positions on the HOEs 32R and 32L.

The lights with respective wavelengths made incident upon the HOEs 32R and 32L are diffracted by the HOEs 32R and 32L, to be sequentially emitted substantially perpendicularly to the outside from the second surface 10b of the light guide plate 10. The lights with respective wavelengths thus emitted as substantially parallel lights form images on the right eye retina and the left eye retina of a user as the virtual image I of the image generated by the image display element 24, respectively. Further, the HOEs 32R and 32L may be imparted with the capacitor action so that a user may observe the virtual image I of an enlarged image. Namely, it may be configured as follows: the light made incident in each more peripheral region of the HOEs 32R and 32L is emitted at an angle so as to be closer to the center of the pupil, and forms an image at the retina of a user. Alternatively, it may be configured as follows: in order for a user to observe the virtual image I of an enlarged image, the HOEs 52R and 52L diffract the lights with respective wavelengths of RGB so that the pixel positional relationship on the HOEs 32R and 32L forms a similar shape enlarged relative to the pixel positional relationship in the effective region of the image displayed in the effective region of the image display element 24.

The air-equivalent optical path length of the light traveling in the light guide plate 10 is shortened with an increase in refractive index. For this reason, by using the respective optical glasses with a high refractive index, it is possible to increase the apparent viewing angle with respect to the width of the image display element 24. Further, since the refractive index is high but the specific gravity can be kept low, it is possible to provide a light guide plate which is lightweight and has the above effect.

The light guide plate 10 thus obtained was integrated in the HMD 1, and an image was evaluated at the position of the eye point. As a result, an image with a high luminance and a high contrast could be observed at a wide viewing angle.

The light guide plate comprised of each of the above optical glasses can be used for a see-through transmission type head mount display, a non-transmission type head mount display, and the like.

The head mount displays each include the light guide plate comprised of the glass with a high refractive index, and thereby are excellent in immersiveness due to a wide viewing angle. The head mount displays are preferable as image display devices for use in combination with information terminals, for use as for providing AR (Augmented Reality), or the like, or for use as for providing movie watching, game, VR (Virtual Reality), and the like.

In the present Example, the head mount display was taken as an example for description. However, the light guide plate may be mounted to other image display devices.

It should be considered that the embodiments disclosed this time are illustrative in all the points, and are not restrictive. The scope of the present disclosure is shown not by the foregoing description, but by the appended claims, and is intended to include the meanings equivalent to the appended claims and all the changes within the scope.

For example, by performing the composition adjustment described in the specification on the glass composition shown above, it is possible to obtain optical glass in accordance with one aspect of the present disclosure.

Further, it is naturally understood that two or more of the matters shown or described as the preferred ranges in the specification can be combined arbitrarily.

What is claimed is:

1. An optical glass,
which comprises SiO₂, B₂O₃, TiO₂, Nb₂O₅, Y₂O₃, La₂O₃, and Gd₂O₃ as essential components,
wherein, on a mass basis,
a mass ratio of a B₂O₃ content to a SiO₂ content (B₂O₃/SiO₂) is less than 1.000,
a mass ratio of Y₂O₃ content to a total content of Y₂O₃, La₂O₃, Gd₂O₃ and Yb₂O₃ (Y₂O₃/(Y₂O₃+La₂O₃+Gd₂O₃+Yb₂O₃)) is more than 0.020, and
a refractive index nd is more than 2.00000.

2. The optical glass according to claim 1,
wherein the mass ratio (Y₂O₃/(Y₂O₃+La₂O₃+Gd₂O₃+Yb₂O₃)) is more than 0.020 and 0.100 or less.

3. The optical glass according to claim 1,
wherein a mass ratio of a TiO₂ content to a total content of SiO₂ and B₂O₃ (TiO₂/(SiO₂+B₂O₃)) is 1.950 or more.

4. The optical glass according to claim 1,
wherein a total content of SiO₂ and B₂O₃ (SiO₂+B₂O₃) is 30.00 mass % or less.

5. The optical glass according to claim 1,
wherein the refractive index nd is 2.08000 or more.

6. The optical glass according to claim 1,
wherein a temperature TI, at which switching to melt is caused in differential scanning calorimetry, is 1247° C. or less.

7. The optical glass according to claim 1,
in which a temperature TI, at which switching to melt is caused in differential scanning calorimetry, is 1245° C. or less.

8. The optical glass according to claim 1,
wherein the mass ratio (Y₂O₃/(Y₂O₃+La₂O₃+Gd₂O₃+Yb₂O₃)) is more than 0.020 and 0.100 or less,
a mass ratio of the TiO₂ content to the total content of SiO₂ and B₂O₃ (TiO₂/(SiO₂+B₂O₃)) is 1.950 or more,
a total content of SiO₂ and B₂O₃ (SiO₂+B₂O₃) is 12.00 mass % or less,
the refractive index nd is 2.08000 or more, and
a temperature TI, at which switching to melt is caused in differential scanning calorimetry, is 1247° C. or less.

9. The optical glass according to 8,
wherein the temperature TI, at which switching to melt is caused in differential scanning calorimetry, is 1245° C. or less.

10. The optical glass according to claim 1,
wherein a SiO₂ content is 0.10% or more and 30.00% or less, and/or
a B₂O₃ content is 0.10% or more and 30.00% or less.

11. The optical glass according to claim 1,
wherein a total content of SiO₂ and B₂O₃ (SiO₂+B₂O₃) is 1.00% or more and 30.00% or less.

12. The optical glass according to claim 1,
wherein a TiO₂ content is 1.00% or more and 50.00% or less, and/or
a Nb₂O₅ content is 1.00% or more and 30.00% or less, and/or
a WO₃ content is 0.00% or more and 8.00% or less.

13. The optical glass according to claim 1,
wherein a total content of TiO₂, Nb₂O₅, and WO₃ (TiO₂+Nb₂O₅+WO₃) is 10.00% or more and 60.00% or less.

14. The optical glass according to claim 1,
wherein a Y₂O₃ content is 0.10% or more and 10.00% or less, and/or
a La₂O₃ content is 10.00% or more and 60.00% or less, and/or
a Gd₂O₃ content is 1.00% or more and 30.00% or less.

15. The optical glass according to claim 1,
wherein a total content of Y₂O₃, La₂O₃, Gd₂O₃, and Yb₂O₃ (Y₂O₃+La₂O₃+Gd₂O₃+Yb₂O₃) is 10.00% or more and 70.00% or less.

16. The optical glass according to claim 1,
wherein the refractive index nd is more than 2.00000 and 2.20000 or less.

17. The optical glass according to claim 1,
wherein an Abbe's number vd is 20.00 or more and 30.00 or less.

18. An optical element comprised of the optical glass according to claim 1.

19. A light guide plate comprised of the optical glass according to claim 1.

20. An image display device, comprising:
an image display element, and
a light guide plate which guides a light emitted from the image display element,
wherein the light guide plate is the light guide plate according to claim 19.
